(19) United States
(12) Patent Application Publication
(10) Pub. No.: US 2014/0174367 A1
(43) Pub. Date: Jun. 26, 2014

(54) METHOD AND APPARATUS FOR FEEDING AND ATTRACTING WILDLIFE

(71) Applicant: Salvatore J. Fama, Monroe Township, NJ (US)

(72) Inventor: Salvatore J. Fama, Monroe Township, NJ (US)

(21) Appl. No.: 13/724,865

(22) Filed: Dec. 21, 2012

(51) Int. Cl. A01K 5/00; B65B 1/04

(52) U.S. Cl. CPC A01K 5/00; B65B 1/04
USPC 119/51.01; 53/467

(57) ABSTRACT

A container for feeding and/or attracting animals, which may have a cylindrical body portion, a top end, and a bottom end opposing the top end, which together define an inside chamber. Each of the top end and the bottom end of the container may be substantially perpendicular to the cylindrical body portion. The cylindrical body portion may have first plurality of openings leading to the enclosed chamber. The apparatus further may be further comprised a plurality of feed particles within the inside chamber, such that one or more of the plurality of feed particles are smaller than each of the first plurality of openings. The bottom end may have a second plurality of openings leading to the inside chamber, each of which are larger than one or more of the plurality of feed particles. The apparatus may further include a pole device, to which the container may be attached.

### FIELD OF THE INVENTION

This invention relates to improved methods and apparatus concerning feeding and attracting wildlife.

### BACKGROUND OF THE INVENTION

U.S. Pat. No. 8,082,882 to Tharp discloses an animal feeder including a cylindrical barrel 100 and an insertable feed restrictor 200. (Tharp, col. 3, Ins. 40-43; FIGS. 1-3). The insertable feed restrictor 200 has a plurality of holes 210 through a bottom circular surface. (Tharp, col. 4, Ins. 32-35; FIG. 3). The cylindrical barrel 100 includes a plurality of fasteners 110 which hold in place a stop 140, (Tharp, col. 4, Ins. 61-62) and a single small drain hole 130 (Tharp, col. 4, Ins. 9-15; FIGS. 8-9). Other than the large opening at the upper end of the barrel 100 to receive feed, and the single small drain hole 130, there are no other openings in the cylindrical barrel 100. (Tharp, col. 3, Ins. 43-46; FIGS. 1, 8, and 9).

The feed restrictor 200 floats on feed within the barrel 100 and changes elevation in response to removal of feed during feeding. (Tharp, col. 6, Ins. 5-8). Tharp discloses catching “the ends of hay, alfalfa, or long stem grasses underneath feed access holes 210” with a spinning feed restrictor 200 and having the “ends of the feed protrude through the feed access holes 210” to become accessible to a feeding animal.” (Tharp, col. 6, Ins. 8-14).

U.S. Pat. No. 7,832,663 to Cotham discloses dispersing granular feed material or seed through a bottom funnel hole 28, a bottom plate 32, a bucket bottom hole 23, and through a first conduit 40. (Cotham, col. Ins. 20-37; FIG. 2). A spreader motor is activated and spreads granular material behind a user from a backpack or from a vehicle. (Cotham, col. 2, Ins. 35-46).

U.S. Pat. No. 5,839,389 to Fuji discloses a feeder in which food within a feeding tank 6 is discharged and loaded onto a disk-like portion 15 and dropped into a bottom plate 2. (Fuji, col. 4, Ins. 16-24; FIG. 1A-B, FIG. 2). U.S. Pat. No. 7,631,614 to Romeu Guardia provides a swing lever 4 to allow an animal to move a tray 2 horizontally to cause feed to fall so it can be consumed. (Romeu Guardia, col. 3, Ins. 30-48; FIG. 2A-2B). U.S. Pat. No. 7,252,049 to Ginsberg provides a wheeled feed hopper 101 which releases food through a bottom funnel 104. (Ginsberg, col. 2, Ins. 14-15; col. 2, Ins. 40-44; FIG. 1 and FIG. 4). U.S. Pat. No. 7,028,635 to Eastman, provides a collapsible reservoir 112 and a bottom funnel 114 to distribute food from. (Eastman, col. 2, Ins. 35-41; FIG. 3A).

U.S. Pat. No. 6,578,517 to Borries discloses an animal feeder device 1 which is typically attached by flange 5 to a bottom of a large container of dry food. (Borries, col. 2, Ins. 37-38). The feeder device 1 includes vents 7 through a tapering outer cone 6. (Borries, col. 2, Ins. 45-54; FIG. 2). The vents 7 are use to allow an animal to smell the dry feed within the feeder, but are small enough so that feed does not readily fall to the ground. (Borries, col. 2, Ins. 52-65). The feeder device is configured so that food comes through a second end 4, when an animal presses up against actuator 9 (Borries, col. 3, Ins. 6-11; FIGS. 3A-3B), however additionally, the slits or vents 7 can be made wider at the top of cone 6 so that “minimal” dry food is forced up and out of outer cone 6 by movement of an actuator 9. (Borries, col. 3, Ins. 11-13). In an alternative embodiment, the vents 7 can be replaced by round holes drilled in outer cone 6. (Col. 3, Ins. 11-13).

U.S. Pat. No. 6,571,734 to Finklea discloses channels 11 which channel feed to feed ports 22 by gravity. (Finklea, FIG. 5; col. 3, Ins. 11-16).

### SUMMARY OF THE INVENTION

In at least one embodiment an apparatus is provided, for feeding and/or attracting wildlife, which includes a container. The container may have a cylindrical body portion, a top end, and a bottom end opposing the top end, which together define an inside chamber. In other embodiments, the container may be a different three dimensional shape that can roll such as a sphere or round ball shape or some other three dimensional shape that can roll. Each of the top end and the bottom end of the container may be substantially perpendicular to the cylindrical body portion. The cylindrical body portion may have first plurality of openings leading to the enclosed chamber. The apparatus further may be further comprised a plurality of feed particles within the inside chamber, such that one or more of the plurality of feed particles are smaller than each of the first plurality of openings. The bottom end may have second plurality of openings leading to the inside chamber, each of which are larger than one or more of the plurality of feed particles. The apparatus may further include a lid attached to the top end of the container. The apparatus may further include a cord having a first end and a second end; wherein the first end of the cord is attached to the container. The apparatus may further include a pole device; wherein the second end of the cord is attached to the pole device. The container may have a handle; and the first end of the cord may be attached to the handle of the container.

In at least one embodiment a method is provided which may include inserting a plurality of feed particles into an inside chamber of a container; sealing the feed particles inside of the inside chamber of the container except for a plurality of openings in the container, wherein each of the plurality of openings is larger than one or more of the plurality of feed particles; placing the container, as sealed with the plurality of feed particles in the inside chamber of the container, on an outdoor ground surface; and attaching the container, as sealed with the plurality of feed particles in the inside chamber of the container, to a pole device.

In another embodiment a method is provided which may include inserting a plurality of feed particles into an inside chamber of a container; sealing the feed particles inside of the inside chamber of the container except for a plurality of openings in the container, wherein each of the plurality of openings is larger than one or more of the plurality of feed particles; and attaching and hanging the container, as sealed with the plurality of feed particles in the inside chamber of the container, from a pole device, such as a tree, so that the container is above an outdoor ground surface.

In yet another embodiment, the container is attached and hung from the pole device, in a manner which allows the cylindrical body portion of the container to rotate about an axis, but otherwise does not allow the container to move substantially; and wherein the axis is through a center of the cylindrical body portion and parallel to a length of the cylindrical body portion.

### BRIEF DESCRIPTION OF THE DRAWINGS

FIG. 1 shows a top perspective front view of a first container into which food for wildlife can be placed in accordance with an embodiment of the present invention;

FIG. 2 shows a top perspective rear view of the first container of FIG. 1;

FIG. 3 shows a top perspective left view of the first container of FIG. 1;

FIG. 4 shows a top perspective right view of the first container of FIG. 1;

FIG. 5 shows a bottom perspective front view of the first container of FIG. 1;

FIG. 6 shows a bottom perspective rear view of the first container of FIG. 1;

FIG. 7 shows a top perspective front view of a lid for placing on top of the first container of FIG. 1;

FIG. 8 shows a top perspective front view of the lid of FIG. 7 placed on the first container of FIG. 1;

FIG. 9 shows a rear perspective front view of an apparatus including the lid of FIG. 7 placed on the first container of FIG. 1;

FIG. 10 shows a top perspective front view of a second container with the use of dashed lines;

FIG. 11 shows a top perspective front view of the first container of FIG. 1 placed in the second container of FIG. 10;

FIG. 12 shows a simplified diagram of the apparatus of FIG. 9 tied to a tree or pole;

FIG. 13 shows a simplified diagram of the apparatus of FIG. 9 hanging from a branch of a tree or pole;

FIG. 14 shows a simplified diagram of a clear plastic bag containing a plurality of grains, particles or items of feed;

FIG. 15 shows a top, front perspective view of the first container of FIG. 1, with particles of grain or feed placed inside of a chamber of the first container of FIG. 1; and

FIG. 16 shows front perspective view of the apparatus of FIG. 9, attached to a device which allows the apparatus of FIG. 9 to rotate about an axis.

### DETAILED DESCRIPTION OF THE DRAWINGS

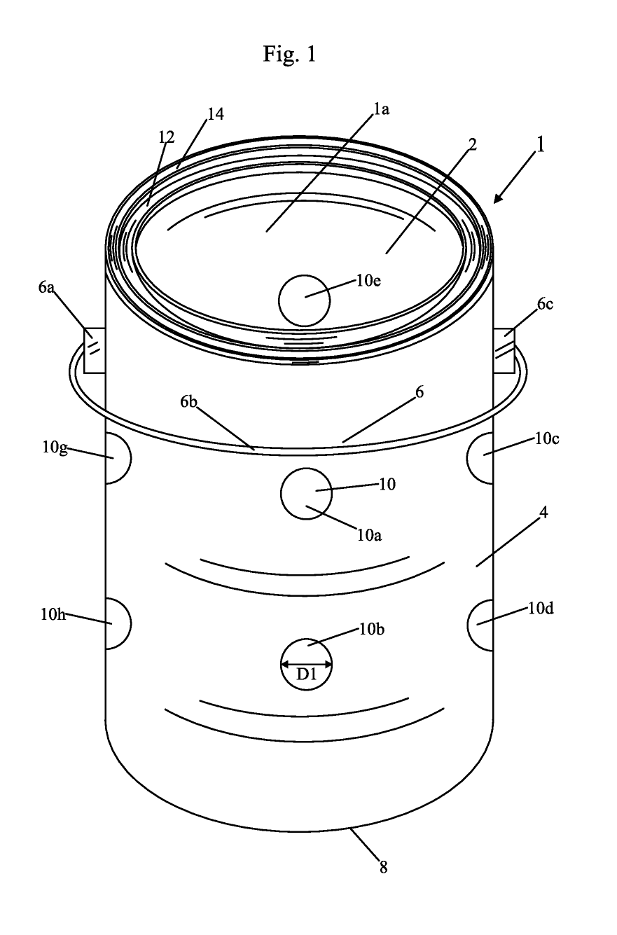

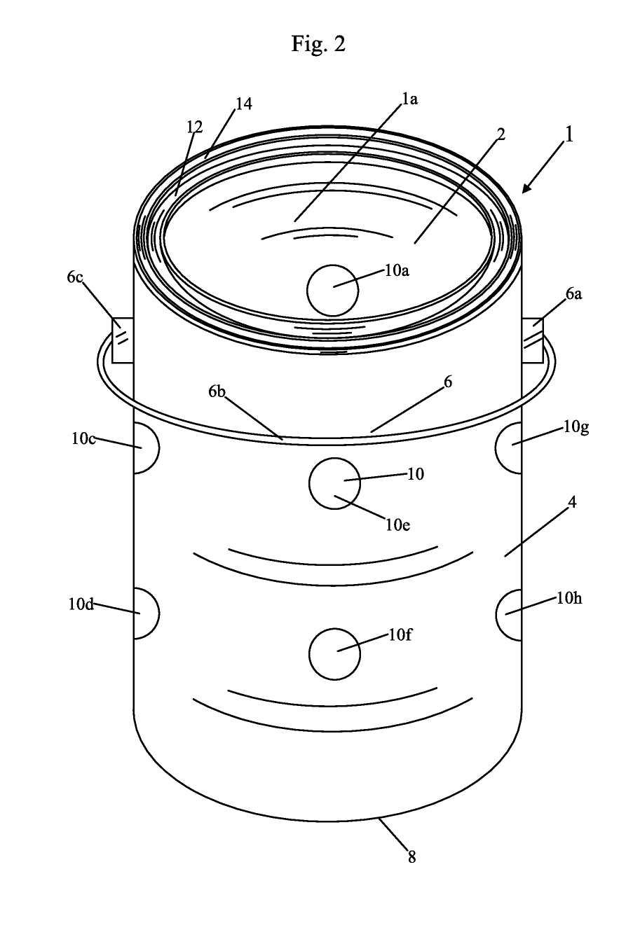

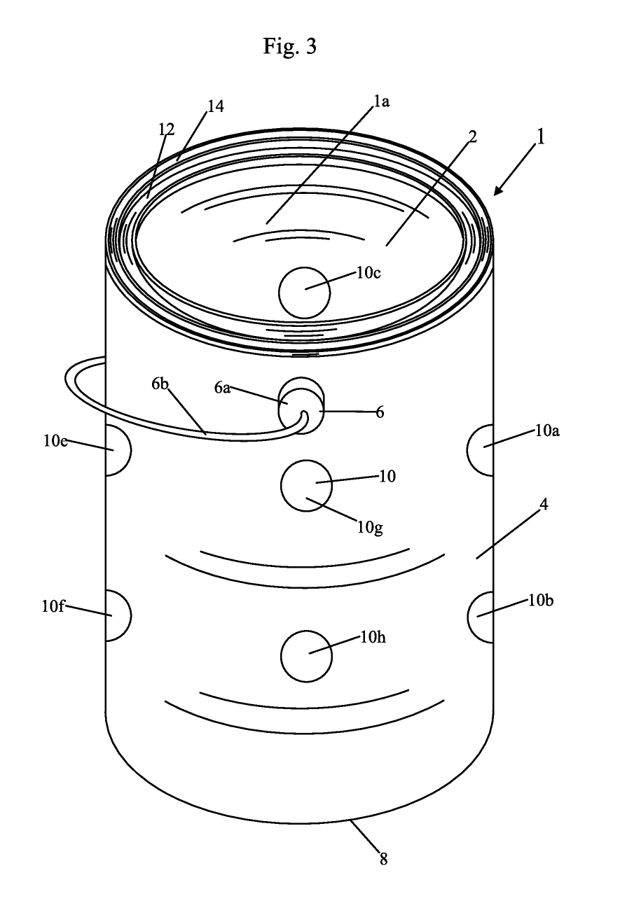

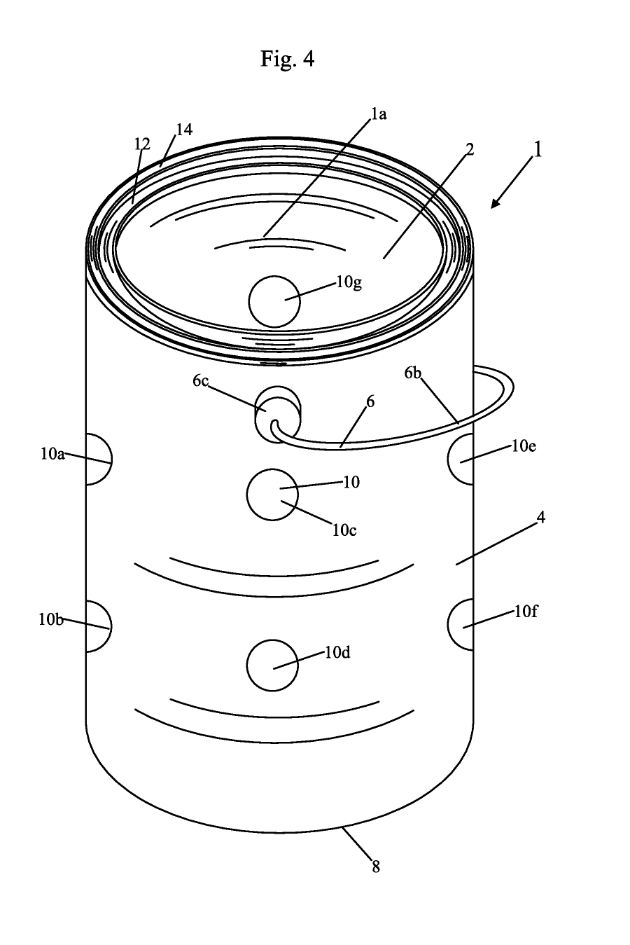

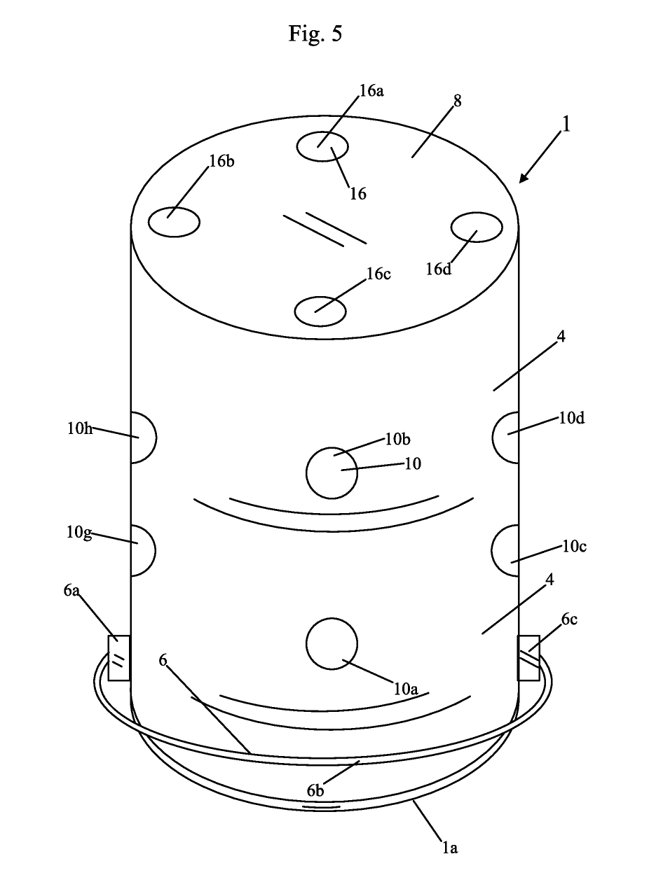

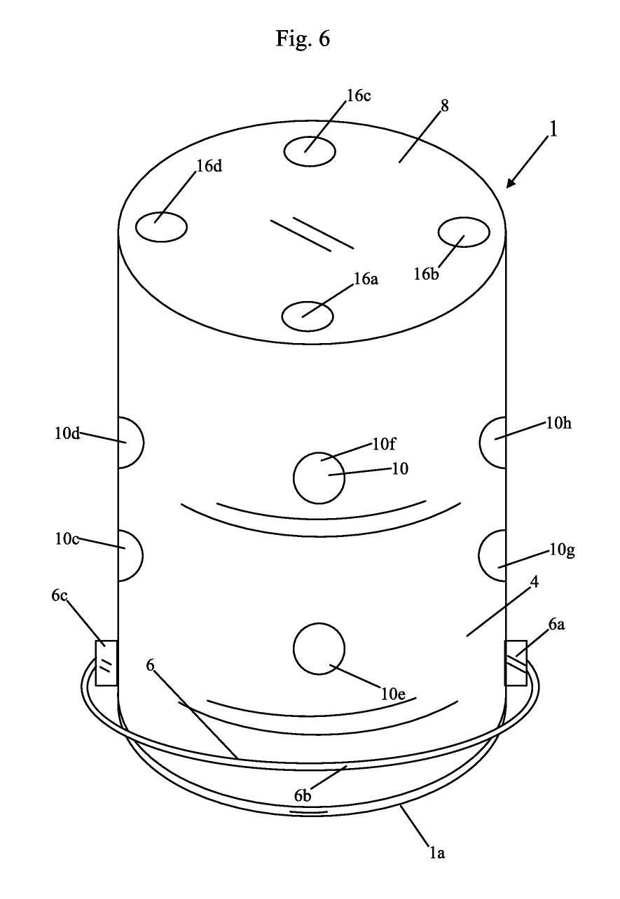

FIG. 1 shows a top perspective front view of a first container 1 into which food for wildlife or can be placed in accordance with an embodiment of the present invention. FIGS. 2-4 show top perspective rear, left, and right views, respectively, of the first container 1. FIGS. 5-6 show bottom front and bottom rear perspective views, respectively, of the first container 1.

Referring to FIGS. 1-6, the first container 1 includes a cylindrical body portion 4 and an end portion 8. The first container 1 also includes a handle device 6. The handle device 6 includes attachment devices 6a and 6b which attach a handle portion 6b, which may be made of metal or other rigid material, to the cylindrical body portion 4. The handle portion 6b may be attached so that the handle portion 6b can pivot up and over a top opening 1a of the cylindrical body portion 4. For example, in FIG. 1, the handle portion 6b is shown at the front and in FIG. 2 the handle portion 6b has been pivotted up and over the top opening 1a so that handle portion 6b is now at the rear of the first container 1.

The top opening la leads to an inner chamber 2 within the cylindrical body portion 4. The inner chamber 2 may be closed except for the top opening la, a plurality of openings 10 in the cylindrical body portion 4, and a plurality of openings 16 in the end portion 8.

As shown in FIGS. 1-4, the plurality of openings 10, include openings 10a, 10b, 10c, 10d, 10e, 10f, 10g, and 10h. Although eight openings for openings 10 are shown, more or less openings can be provided in the cylindrical body portion 4. As shown in FIGS. 5-6, the plurality of openings 16, include openings 16a, 16b, 16c, and 16d. Each of the openings 10a-10h and 16a-16d may be circular and may have a diameter, D1, shown in FIG. 1, which may be three-quarters of an inch, in at least one embodiment.

The first container 1 also includes peripheral circular channels 12 and 14 shown in FIGS. 1-4. The first container 1 may be formed from a standard known one gallon paint container, and may have a diameter of about six and one half inches and a height of seven and three quarters inches. The first container may be the same as the standard one gallon paint container except for the plurality of openings 10 and the plurality of openings 16.

In other embodiments, the first container 1 may be of different sizes or may be formed from different containers, such as for example from plastic bucket containers, pipes, and other materials.

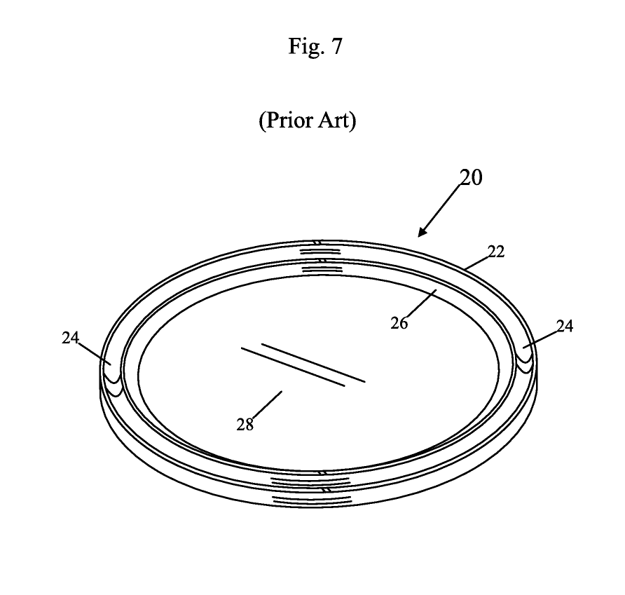

FIG. 7 shows a top perspective front view of a known prior art lid 20 for placing on top of the first container 1. The lid 20 may be a known lid for a one gallon paint container. In other embodiments, the lid 20 may be replaced by other types of lids for other containers.

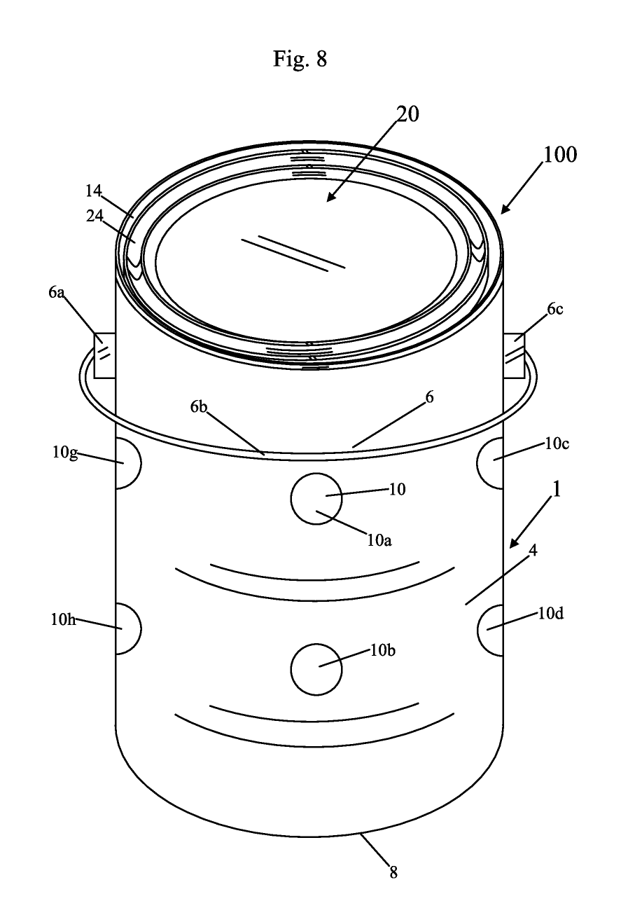

FIG. 8 shows a top perspective front view of an apparatus 100 including the lid 20 placed on the first container 1. The lid 20 is placed in the standard way so that an indentation formed by a channel 24 of the lid 20 sits in the channel 12 of the container 1, to thereby close the opening 1a of the first container 1. With the lid 20 placed on the container 1, as in FIGS. 8 and 9, the chamber 2 is sealed except for the openings 10 in the cylindrical body portion 4 and the openings 16 in the end 8. FIG. 9 shows a rear perspective front view of an apparatus 100.

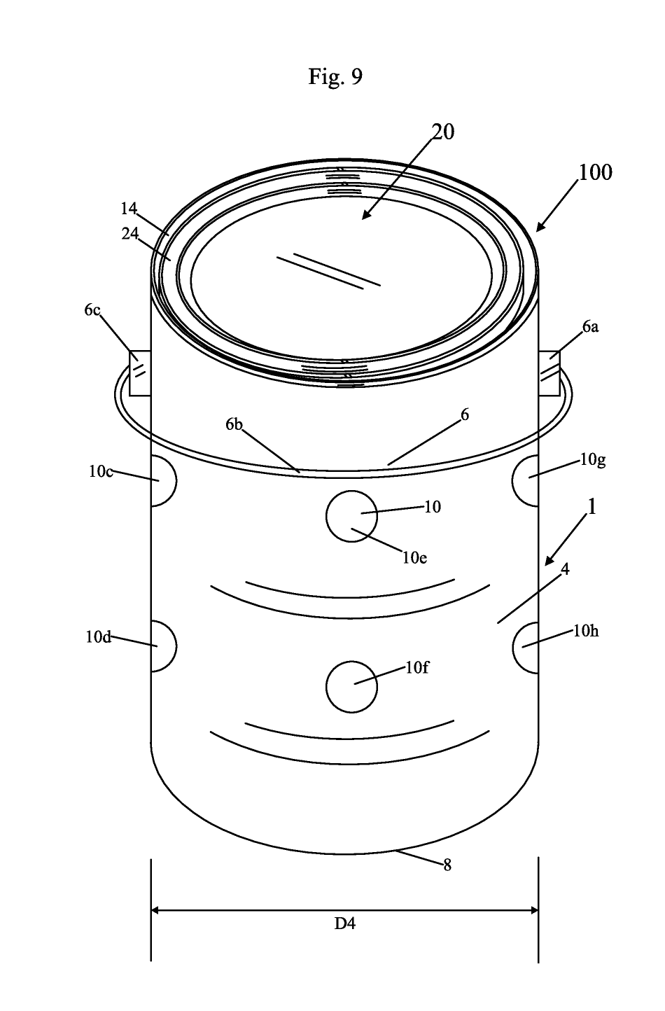

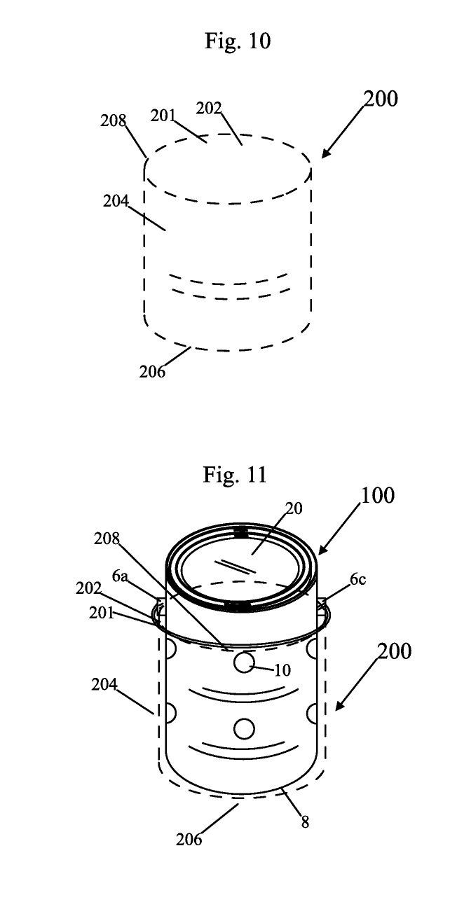

FIG. 10 shows a top perspective front view of a second container 200 with the use of dashed lines. The second container 200 has a top opening 201 leading to an inner chamber 202 within a cylindrical body portion 204. The second container 204 has a closed end 206. The inner chamber 202 is closed except for the opening 201 near the top 208 of the second container 200. The second container 200 may be any type of container, such as a bucket container, a paint container or some other type of container.

FIG. 11 shows a top perspective front view of the first container 1 placed in the second container 200. The first container 1 and the second container 200 are configured and structured with respect to the each other so that the cylindrical body portion 204 of the second container 200 will block the openings 10 in the cylindrical body portion 4 and the openings 16 in the end portion 8, to prevent and/or inhibit feed particles from coming out of the chamber 2 of the first container 1, or additionally or alternatively out of the inner chamber 202 of the second container 200. In at least one embodiment all of the openings 10 are configured to be below the attachment devices 6a and 6c, so that the second container 200 can block the openings 10, the first container 1 snugly fits within the second container 200, the attachment devices 6a and 6c do not both fit within the second container 200. The second container 200 may be or may be made entirely or substantially of a translucent shrink wrap material.

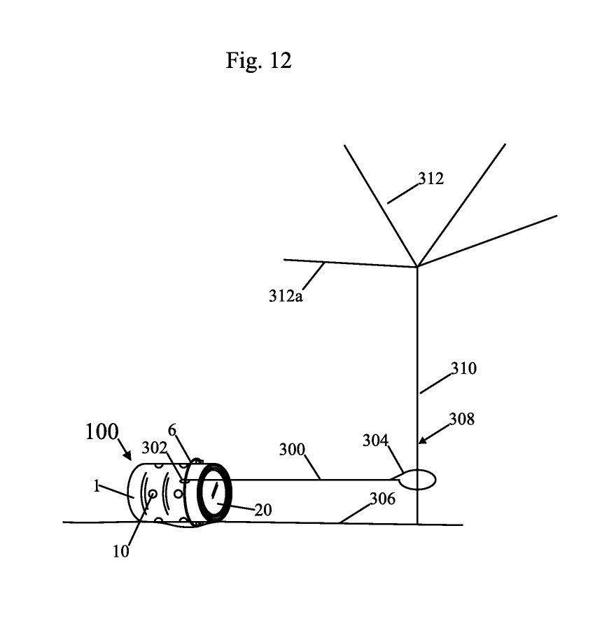

FIG. 12 shows a simplified diagram of the apparatus 100 tied to a tree or pole device 308. In FIG. 12, the apparatus 100 sits on a ground surface 306, which may be in a forest, for example. The handle 6 of the first container 1 is tied to a trunk 310 of the tree or pole device 308 by a loop or knot 302 attached to the handle 6, a rope or cord 300 attached to 302, and a loop or knot 304 attached to the rope or cord and to the trunk 310. The tree or pole device includes a plurality of branches 312 including branch 312a.

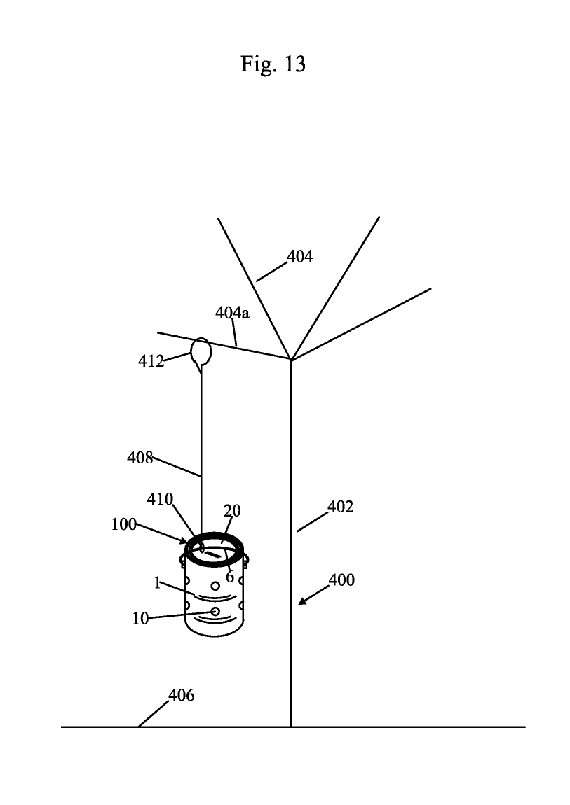

In operation, in at least one embodiment particles of food are placed in the chamber 2 of the first container 1 before the lid 20 is placed on the top of the first container 1. After the particles of food have been placed in the chamber 2, the lid 20 is placed on the top of the first container 1 to form apparatus 100 as in FIGS. 8-9. Then, the apparatus 100 is tied to the trunk 310 as in FIG. 12 or hung from a branch, such as branch 404a in FIG. 13. In other embodiments, the apparatus 100 may not be tied or attached to the tree or pole device 308 but rather may be just placed on the ground surface 306.

FIG. 13 shows a simplified diagram of the apparatus 100 of FIG. 9 hanging from a branch 404a of a tree or pole device 400. FIG. 13 shows ground surface 406 of a forest or other outdoor area. The tree or pole device 400 includes trunk 402, and a plurality of branches 404 including a branch 404a. The apparatus 100 in FIG. 13 is hung and attached to the branch 404a by loop or knot 410 attached to the handle portion 6, rope or cord 408 attached to loop or knot 410, and loop or knot 412 attached to the rope or cord 408 and attached to the branch 404a.

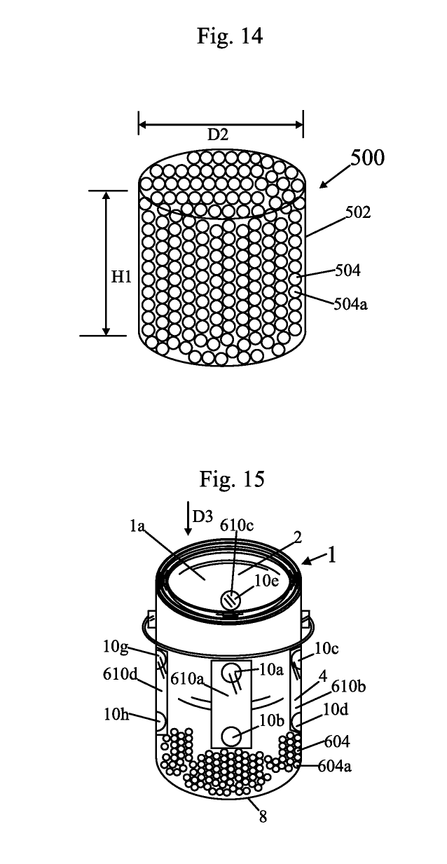

FIG. 14 shows a simplified diagram of an apparatus 500 including a bag 502, such as a clear plastic bag, and a plurality of grains or particles of feed 504, which may include a grain or particle of feed 504a. The bag 502 may be substantially cylindrical. In at least one embodiment, the contents of apparatus 500 may be inserted into the chamber 2 of the first container 1 before the lid 20 is placed on top of the first container 1. The lid 20 may thereafter be placed on the top of the container 1 to form apparatus 100 with the apparatus 500 and the bag 502 enclosed inside the chamber 2. In at least one embodiment, the bag 502 has a dimension or diameter D2, a height H1, each of which are substantially greater than the diameter or dimension of any of the plurality of openings 10 and 16 of the first container 1, so that the bag 500 will not slip out of any of the openings 10 and 16. For example, the bag 502 may have a diameter D2 of five inches, and a height, H1, of seven inches, i.e. somewhat less than the dimensions of a standard one gallon paint container, when the first container 1 in at least one embodiment is a standard one gallon paint container. Each of the feed particles 504, such as feed particle 504a may have a diameter of less than the diameter D1 of each of the openings 10 and 16, so that each of the feed particles 504 can fit through each of the openings 10 and 16.

In at least one embodiment, the bag 500 is not used. Rather, the feed particles 504 are placed directly into the chamber 2 of the container 1, while the openings 10 and 16 are covered by a material, such as in one embodiment, a shrink wrap material, such as 610a, 610b, 610c, and 610d, shown in FIG. 15. The shrink wrap material for 610a-d may be of the type used on a cap of a Scope (trademarked) mouthwash bottle or the cap of a typically medicine bottle. The typically clear film of the shrink wrap material 610a-d, will not allow the feed particles 504, such as corn or other feed material to pour out when the can/bucket, i.e. chamber 2 of the container 1, is filled. The shrink wrap materials 610a-d will also typically be transparent, in at least one embodiment, so the consumer can see the feed particles 504 that are inside the feeder or inside the chamber 2 of the container 1. The shrink wrap materials 610a-d can be easily torn off of the outside of the container 1, by a consumer, to allow the feed particles 504 to escape from the chamber 2 of the container 1 to the outside of the container 1.

Generally, in operation, particles of feed 504 are placed inside the chamber 2 and then the lid 20 is placed on top of the first container 1. Then the apparatus 100, with the feed particles inside is attached to a tree or pole device as in FIG. 12 or FIG. 13. A deer or other wildlife will be attracted by the scent of the particles, and by nudging, hitting, kicking, and/or otherwise moving or impacting the apparatus 100, some, but not all of the feed particles will escape from the chamber 2 out of the holes 10 and 16 and out of the apparatus 100, so that the wildlife can eat them. However not all of the feed particles will escape from the chamber 2 at one time, and feed particles can remain at the site where the apparatus 100 is attached, such as in FIGS. 12 and 13, to attract wildlife without having to add food for a long period of time. If feed particles were laid out without the apparatus 100, the feed particles would be eaten very quickly, and would have to be replaced quickly. The animals would move on after a short period of time after not finding food in the location.

FIG. 15 shows a top, front perspective view of the first container 1 of FIG. 1, with a plurality of particles of grain or feed 604, such as particle 604a, placed inside of a chamber 2. In at least one embodiment, during the manufacturing process, the feed particles 604 will be poured into the chamber 2 of the container 1, after the shrink wrap or tape materials 610a-d is placed over the outside of the container 1 in locations to cover the openings 10 and 16. The cylindrical body portion 4 is assumed to be transparent so that the feed 604 can be seen for explanatory purposes in FIG. 15. Each particle, such as 604a is smaller than each of the openings 10 and 16. In at least one embodiment, before the particles 604 are placed in the inside chamber 2, the openings 10 are covered with tape or plastic or sealed off with some other removable adhesive material. For example, in FIG. 15, transparent tape or shrink wrap 610a is secured to the cylindrical body portion 4 and is used to cover openings 10a and 10b, transparent tape or shrink wrap 610b is secured to the cylindrical body portion 4 and is used to cover openings 10c and 10d, transparent tape or shrink wrap 610c is secured to the cylindrical body portion 4 and is used to cover openings 10e and 10f, and transparent tape or shrink wrap 610d is secured to the cylindrical body portion 4 and is used to cover openings 10g and 10h. In this manner, transparent tapes 610a-d prevents any feed particles from coming out of the openings 10. Similarly transparent tape or shrink wrap, not shown may be secured to the end portion 8 and may cover the openings 16 to prevent any feed particles from coming out of the openings 16. The apparatus 100 may be sold with the particles 604 inside of the chamber 2 and with the tapes 610a-d covering openings 10 and similar tapes covering openings 16. When a individual wants to use the apparatus 100, as in FIGS. 12 and 13, to attract wildlife for hunting or some other purpose, he or she can remove the tapes 610a-d and similar or identical tape from openings 16, and thereby allow the feed particles 604 to be accessed or to fall out of the container 1 through openings 10 and 16, which the apparatus 100 is sufficiently moved or impacted. Note that the tapes 610a-d and similar or identical tapes for openings 16, would typically be applied from the outside of cylindrical body portion 4 (for openings 10) and end portion 8 (for openings 16), so that the tapes 610a-d and similar or identical tapes for openings 16 can be easily removed after placing apparatus 100 on a ground surface, such as 306 in FIG. 12. Note that feed particles 504 could be sold in a bag, such as in FIG. 14, but then the particles 504 would typically be poured into the chamber 2 of the container 1, after the openings 10 and 16 had been covered by shrink wrap or covering materials 610a-d.

After the particles 604 are placed in the chamber 2, the lid 20 may be sealed and secured attached to the container 1 (for example, as a paint can lid is sealed to a standard paint can container) such as by pressing down hard in the direction D3 onto the top of the container 1. Then the apparatus 100 with the particles 604 can be tied to a tree or pole device as in FIGS. 12 and/or FIG. 13. When an animal impacts the apparatus 100, the particles 604 will move and some will fall out of the apparatus 100 through the holes 10 and/or 16. Over time the particles 604 will gradually be dispersed for feed in this manner.

The apparatus 100 as shown by FIGS. 12 and 13, can be used to dispense corn, other food items or minerals capable of fitting through any one or all of the plurality of holes 10 and 16 of the container 1. The apparatus 100 can be constructed in a number of ways and utilizing a number of different materials, such as buckets, piping, barrels and cans. In at least one embodiment, buckets and cans would be the least expensive and have a convenient carrying handle 6. The apparatus 100 can be used to attract bears, and in that case, in at least one embodiment, a more rigid material, such as a metal pipe version or barrel version, for the apparatus 100 should be used. Once all the feed has been emptied from the inside chamber 2 of the container 1, typically by an animal, the purchaser can refill the inside chamber 2 of the container 1.

In at least one embodiment, the apparatus 100 can be used to dispense corn and can be constructed using a two gallon painter's leak tight bucket for container 1 and for lid 20 as follows: A two gallon painters' bucket for container 1 can be drilled with twelve, ¾ inch holes for holes 10. Larger holes can be drilled for holes 10 which will dispense the feed at a faster rate.

The apparatus 100 can be marketed by the length of time the feed will last in the container 1 or apparatus 100. The positioning and spacing of the plurality of holes 10 in one embodiment, are as follows: Two holes of holes 10 can be drilled from top to bottom on each of the four sides of the cylindrical body portion 4 of the container or bucket 1. The spacing, center to center, between the holes 16 also can be drilled into the bottom end or portion 8 of the bucket or container 1 two holes, on each side, such as holes 10a and 10b, may be about four inches. Four holes for one inch from the outer or peripheral edge of the portion 8, in line with the holes 10 drilled on the sides.

Once the holes 10 and 16 are drilled, in at least one embodiment they can be covered with clear plastic, tape, or the bucket or container 1 can be placed into another identical bucket or container, such as in FIG. 11, to prevent the corn or other feed item from spilling out of holes or openings 10 and 16. If the apparatus 100 were to be sold commercially, a plastic tight fitting encapsulating plastic shrink wrap material, such as for bag 502 could be used which may hold product information, logo, Universal Product Code (UPC) code, and directions for use. Alternatively, product information, logo, UPC code, and directions for use could be placed on the apparatus 200 shown in FIG. 10, on the materials 610a-d for covering the openings 10 and 16, or on the exterior of the cylindrical body portion 4 of the container 1 of FIG. 1.

The bucket or container 1 would be filled with the feed particles, such as plurality of feed particles 600 shown in FIG. 15. Typically the feed particles would fill the entire chamber 2 of the container 1, although for ease of description the container 1 is shown only partly filled in FIG. 15. After the feed particles have been placed in the inside chamber 2, the lid 20 would be affixed fixed and sealed to the top of container 1 form apparatus 100. The lid 20 could be a snap on or screw on type lid.

Once in the place the hunter or biologist wants to begin feeding, he or she would remove the clear plastic, tape or the second bucket used to prevent the corn or other feed from falling out of the openings or holes 10 and 16. The apparatus 100 would be laid onto the ground, such as ground surface 306 as shown in FIG. 12, on the cylindrical body portion 4 (i.e. on its side) so as to maximize the movement of the apparatus 100 when impacted by an animal, such as a deer. When the apparatus 100 is agitated by deer or other animals, the corn or other feed will trickle out of the openings 10 and 16 onto the ground surface 306. The deer will dig for the corn or other feed item and either directly move the apparatus 100 to dispense the corn or other feed item or indirectly move the apparatus 100 by digging around the area for the corn or other feed item that have fallen out previously. The feed will dispense as the apparatus 100 rolls around on the ground surface 306. The energy provided by the movement of the apparatus 100 is part of the dispensing mechanism. Kinetic energy stored in the corn pushing against the pail or container 1 or apparatus 100 will be released as the apparatus 100 moves. The movement will be supplied by animals pushing on the apparatus 100, digging, other environmental energy such as heat, wind, rain water flow, soil shift.

One of the advantages of the apparatus 100 above other devices is that this device will allow for the slow dispensing of corn or other feed items over a longer period of time. The hunter will not have to purchase as much corn and will not have to store, transport, and then carry regular amounts of corn into the woods just to keep a baited hunting location fresh with feed. The hunter can choose which size/dispensing speed bucket or apparatus 100 he wants, grab the apparatus 100 off the shelf at a retailer, remove the wrapper or tape from the holes 10 and 16 and place the apparatus 100 in the woods. The area will stay baited for the duration keeping the location fresh with feed.

In addition, the apparatus 100 will hold deer and other animals in the area longer and will not allow the animal to fill up over a very short period, giving the hunter more opportunity to see and harvest the animal. It will keep the game animal coming back to eat the kernels it always finds in the spot. The animal may learn that moving the apparatus 100 or digging around it will cause more food to be found, hence a rewarded response. In addition, the animal will be concentrating on digging and finding small quantities of corn or other feed items than it would should the hunter have placed regular larger quantities of corn or other feed items into the woods. During the hunt, the smaller amounts of corn or other feed items on the ground will further divert the animals' attention away from its surroundings where the hunter might have been more regularly spotted giving the hunter better opportunity to position his weapon for the shot in order to harvest the animal.

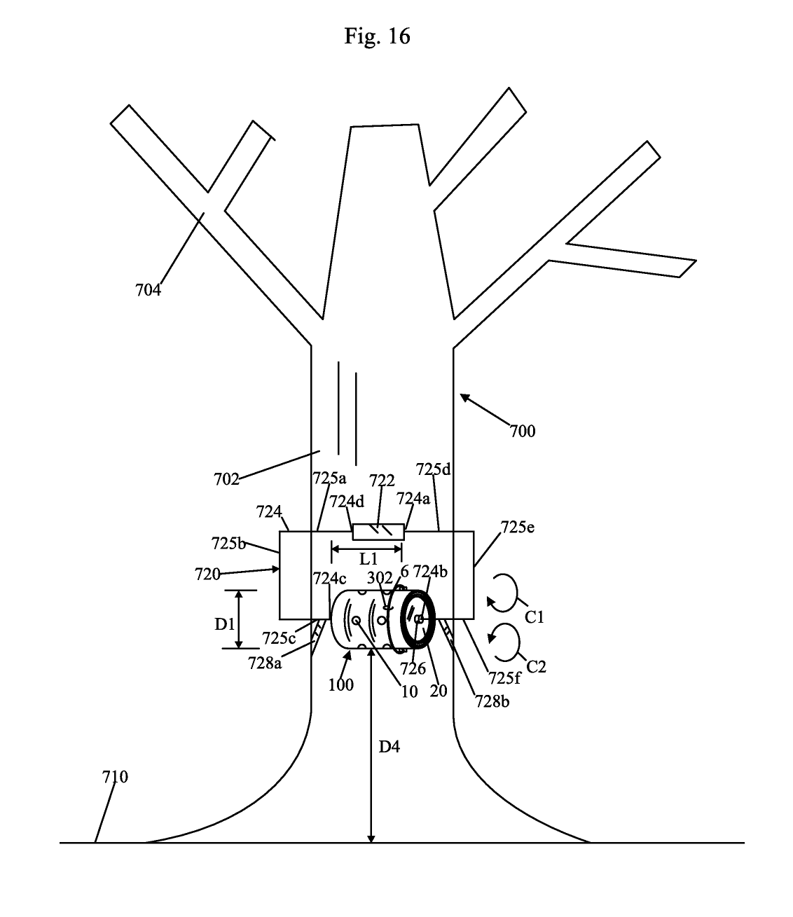

FIG. 16 shows a front perspective view of the apparatus 100 of FIG. 9, attached by a device 720 to a pole device 700, which allows the apparatus 100 of FIG. 9 to rotate about an axis passing through the center of the apparatus 100 and parallel to a length of the apparatus 100.

The pole device 700 may be a tree having a trunk 702 and branches 706. The pole device or tree 700 may be rooted outdoors in ground 710.

The device 720 includes an attachment device 722 which secures the device 720 to the trunk 702 of the pole device or tree 700. The attachment device 722 may be secured by nailing, screwing, or any other known fastening method, to the pole device or tree 700. The device 720 includes a member 724 having ends 724a and 724d fixed to attachment device 722 and ends 724b and 724c rotatably fixed to opposing ends of apparatus 100. The end 724b is rotatably fixed to a device 726, at the top of the lid 20 of apparatus 100 and the end 724c is rotatably fixed to a device similar or identical to the device 726, at the bottom of the apparatus 100, in a manner which allows the apparatus 100 to rotate in a clockwise direction C1 or a counter clockwise direction C2 about an axis, passing through the center of the cylindrical body of the apparatus 100, which is parallel to the length L1 of the apparatus 100, and perpendicular to the width or diameter D4, shown in FIG. 9 and FIG. 16.

The device 720 also includes member 728a and 728b which can be used in at least one embodiment to maintain the apparatus 100 at a distance away from the trunk 702 so that when the apparatus 100 rotates in direction C1 or C2, the apparatus 100 does not contact or rub against the trunk 702. A top part 725a of member 724 may contact the trunk 702, a middle part 725b may be slanted away from the trunk 702, and a bottom part 725c may be a distance away from the trunk 702, as determined by the member 728a. Similarly, a top part 725d of member 724 may contact the trunk 702, a middle part 725e may be slanted away from the trunk 702, and a bottom part 725f may be a distance away from the trunk 702, as determined by the member 728b. The members 728a and 728b may be fixed at one end to the trunk 702 of the pole device or tree 700, such as by nailing, screwing, or fastening in some other manner, and at an opposing end they may be fixed to the member 724, such as by welding or in some other manner. The member 724 and the members 728a and 728b may be made of rigid metal.

The apparatus 100 may be secured by the attachment device 722 to the trunk 702 so that the so that the cylindrical body portion 4 of the container 1 is parallel to the ground 710, and is fixed a distance D4 above the ground 710. The distance D4 may be one to three feet to allow an average sized deer to nudge or otherwise contact the apparatus 100, to cause the apparatus 100 to rotate in the directions C1 and/or C2 and to thus cause feed particles to fall out of the openings 10 or 16, out of the inner chamber 2 of the apparatus 100 and onto the ground 710. The apparatus 100 in FIG. 16, may basically be attached to the pole device 700 like a toilette paper roll. The cylindrical body portion 4 may spin in the directions C1 and/or C2, with external energy supplied by contact with animals, and also by wind, and tree movement.

The apparatus 100 may be attached and hung from the pole device 700, as shown in FIG. 16, in a manner which allows the cylindrical body portion 4 of the container 1 to rotate about an axis, but otherwise does not allow the container 1 to move substantially, wherein the axis is through a center of the cylindrical body portion 4 and parallel to a length L1 of the cylindrical body portion 4.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a container;
wherein the container has a cylindrical body portion, a top end, and a bottom end opposing the top end, which together define an inside chamber;
wherein each of the top end and the bottom end of the container is substantially perpendicular to the cylindrical body portion;
wherein the cylindrical body portion has a first plurality of openings leading to the enclosed chamber;
and wherein the apparatus further comprises a plurality of feed particles within the inside chamber, such that one or more of the plurality of feed particles are smaller than each of the first plurality of openings.

2. The apparatus of claim 1 wherein
the bottom end has a second plurality of openings leading to the inside chamber, each of which are larger than one or more of the plurality of feed particles.

3. The apparatus of claim 1 further comprising
a lid attached to the top end.

4. The apparatus of claim 1 further comprising
a cord having a first end and a second end; and
wherein the first end of the cord is attached to the container.

5. The apparatus of claim 4 further comprising
a pole device; and
wherein the second end of the cord is attached to the pole device.

6. The apparatus of claim 4 wherein
the container has a handle;
and first end of the cord is attached to the handle of the container.

7. The apparatus of claim 1 further comprising
adhesive tape; and
wherein the first plurality of openings are covered by the adhesive tape removably attached to an outside surface of the container, so that the plurality of feed particles cannot escape through the first plurality of openings, while the adhesive tape is attached to the outside of the container.

8. A method comprising
inserting a plurality of feed particles into an inside chamber of a container;
sealing the feed particles inside of the inside chamber of the container except for a plurality of openings in the container, wherein each of the plurality of openings is larger than one or more of the plurality of feed particles;
placing the container, as sealed with the plurality of feed particles in the inside chamber of the container, on an outdoor ground surface; and
attaching the container, as sealed with the plurality of feed particles in the inside chamber of the container, to a pole device.

9. The method of claim 8 wherein
the pole device is a tree.

10. The method of claim 8 wherein
the container includes a cylindrical body portion, a top end, and a bottom end opposing the top end, wherein each of the top end and the bottom end are substantially perpendicular to the cylindrical body portion; and
wherein a first plurality of the plurality of openings are through the cylindrical body portion of the container, and lead to the inside chamber.

11. The method of claim 10 wherein
the bottom end has a second plurality of the plurality of openings, which lead to the inside chamber;
wherein each of the second plurality of the plurality of openings is larger than one or more of the plurality of feed particles.

12. The method of claim 8 wherein
the container is attached by a cord to the pole device.

13. The method of claim 8 further comprising
removably attaching adhesive tape to an outside surface of the container, such that the plurality of openings are covered by the adhesive tape, so that the plurality of feed particles cannot escape through the first plurality of openings from the inside chamber of the container, while the adhesive tape is attached to the outside of the container and covers the plurality of openings.

14. A method comprising
inserting a plurality of feed particles into an inside chamber of a container;
sealing the feed particles inside of the inside chamber of the container except for a plurality of openings in the container, wherein each of the plurality of openings is larger than one or more of the plurality of feed particles; and
attaching and hanging the container, as sealed with the plurality of feed particles in the inside chamber of the container, from a pole device, so that the container is above an outdoor ground surface; and
wherein the container includes a cylindrical body portion, a top end, and a bottom end opposing the top end; and
wherein a first plurality of the plurality of openings are through the cylindrical body portion of the container and lead to the inside chamber.

15. The method of claim 14 wherein
the feed particles are sealed inside the inside chamber of the container except for the plurality of openings in the container, by sealing a lid to the top end of the container.

16. The method of claim 14 wherein
a second plurality of the plurality of openings are located in the second end of the container, wherein each of the second plurality of the plurality of openings are larger than one or more of the plurality of feed particles.

17. The method of claim 14 wherein
the container is attached and hung by a cord.

18. The method of claim 17 wherein
the container includes a handle;
and wherein the container is attached and hung by attaching a first end of the cord to the handle and a second end of the cord to the pole device.

19. The method of claim 14 wherein
the pole device is a tree.

20. The method of claim 14 further comprising
removably attaching adhesive tape to an outside surface of the container, such that the plurality of openings are covered by the adhesive tape, so that the plurality of feed particles cannot escape through the first plurality of openings from the inside chamber of the container, while the adhesive tape is attached to the outside of the container and covers the plurality of openings.

21. The method of claim 14 wherein
the container is attached and hung from the pole device, in a manner which allows the cylindrical body portion of the container to rotate about an axis, but otherwise does not allow the container to move substantially; and
wherein the axis is through a center of the cylindrical body portion and parallel to a length of the cylindrical body portion.
